(19) United States
(12) Patent Application Publication
(10) Pub. No.: US 2005/0091919 A1
(43) Pub. Date: May 5, 2005

(54) Portable plant container apparatus and method

(76) Inventors: Heather Weiner, Philadelphia, PA (US); Barent Roth, Philadelphia, PA (US)

Correspondence Address: HAHN LOESER & PARKS, LLP, One GOJO Plaza, Suite 300, AKRON, OH, 44311-1076, US

(21) Appl. No.: 10/954,854

(22) Filed: Sep. 30, 2004

Related U.S. Application Data
(63) Continuation-in-part of application No. 10/354,369, filed on Jan. 30, 2003, now abandoned.
(60) Provisional application No. 60/353,010, filed on Jan. 30, 2002.

(51) Int. Cl. A01G 9/02

(52) U.S. Cl. 47/66.6

(57) ABSTRACT

A portable plant container apparatus which can be worn by a user which allows constant monitoring of the growth of a plant. The portable plant container comprises a base and a cover securable to a user which houses a living plant growing in a tissue culture medium. The apparatus is transparent allowing visual monitoring of the plant growth. The method of using the device provides for growing the plant in the device and then transplanting the plant into the soil of a larger container.

This application is a continuation-in-part of U.S. Non-Provisional patent application Ser. No. 10/354,369, filed Jan. 30, 2003 which claims the benefit of U.S. Provisional Patent Application Ser. No. 60/353,010 filed Jan. 30, 2002, both applications hereby incorporated by reference.

### TECHNICAL FIELD

The present invention relates to a method and apparatus for containing and displaying a plant. More specifically this invention relates to a method and portable apparatus containing a plant culture medium which permits seed germination and is worn by a person.

### BACKGROUND OF THE INVENTION

Seed germination and plant growth are fundamental biological processes of great scientific, educational and commercial interest. In particular, parents and teachers often wish to present plant growth to children and students, respectively, in a way that is both informative and dynamic, allowing observations of growth and development over time. However, the growth can typically only be viewed when visiting the location of the growth, typically in a pot or other container filled with soil. The growth of the shoot, i.e., the aerial portions of the plant (leaves, flowers and fruits), can be directly observed, the germinating seed, as well as the developing root system, which is often as extensive as that of the shoot system, are usually buried in the soil. Thus, seed germination and the developing root system are typically obscured.

Plants can be grown aseptically in tissue culture. The practice of growing plants and plant tissues on defined media in closed containers is well developed. Plant tissue culture is typically carried out either in a liquid or semi-solid culture medium or on a solid culture medium solidified with a gelling agent. In both liquid and solid culture, seed germination and the growth and development of shoots and roots can be directly observed because the culture medium is transparent.

Accordingly, there remains a need in the art for a method and portable apparatus which allows constant monitoring of plant growth while providing an aesthetically pleasing and interesting object that can be worn upon the user.

### SUMMARY OF THE INVENTION

The present invention provides a novel method and apparatus for a portable plant container which can be worn by a user which allows constant monitoring of the growth of a plant. These and other advantages are provided by a portable plant container comprising a base portion, a cover portion attached to the base portion and at least partially removable from the base portion, a root chamber formed in the base portion, a growth material positioned in the root chamber, a plant inserted at least partially in the growth material, a growth chamber formed between the root chamber and the cover portion, a clock attached to the base portion and positioned adjacent the cover, and means for attaching the base portion to a user.

These and other advantages of the invention will be apparent as disclosed in the detailed description of the drawings below.

### DESCRIPTION OF THE DRAWINGS

A better understanding of the present invention will be had when reference is made to the accompanying drawings, wherein:

FIG. 1 is a perspective view of a first embodiment of the portable plant container apparatus of the present invention with enclosed plant.

FIG. 2A is a plan view of the portable plant container apparatus of FIG. 1 and FIG. 2B is a side elevational view of the portable plant container apparatus of FIG. 1;

FIG. 3A is a plan view of the root chamber or culture medium container of the portable plant container apparatus of FIG. 1, FIG. 3B is a side elevational view of the root chamber of the portable plant container apparatus of FIG. 1, and FIG. 3C is an end view of the root chamber of the portable plant container apparatus of FIG. 1;

FIGS. 4A-4H is a series of figures showing the method for using the portable plant container apparatus of FIG. 1 and transplanting the growing plant to a larger container in accordance with another embodiment of the present invention;

FIG. 5 is a perspective view of another embodiment of the portable plant container;

FIGS. 6A-6G is a series of figures showing the method for using the portable plant container apparatus of FIG. 5 and transplanting the growing plant to a larger container in accordance with another embodiment of the present invention; and

FIG. 7 is an exploded perspective view of the growth chamber, root chamber, and germinated seed usable with the portable plant container of FIG. 5 in accordance with another embodiment of the present invention.

FIGS. 8A-8E show side, front, perspective, bottom, and top views, respectively, of an embodiment of a wrist band portable plant container utilizing a centrally positioned growth chamber location;

FIGS. 9A-9D show perspective, front, side, and top views, respectively, of a cuff bangle embodiment of the portable plant container;

FIG. 10A-10E show perspective, front, top, left side and right side views, respectively, of an embodiment of a wrist band portable plant container including a clock feature;

FIG. 11A-11E show perspective, front, top, left side, and right side views, respectively, of another embodiment of a wrist band portable plant container including a clock feature;

FIG. 12A-12E show perspective, front, left side, top, and right side views, respectively, of an embodiment of a wrist band portable plant container utilizing a plant need notification feature and a clock feature;

FIG. 13A-13E show perspective, side, front, and top views, respectively, of a cuff bangle embodiment of the portable plant container utilizing pods;

FIG. 14A-14C show a top, front, and side view respectively of a pod storage device for use with an embodiment of the portable plant container; and

FIG. 15A shows a front view of a necklace style embodiment of the portable plant container; FIGS. 15B-15C show a detailed perspective, front, and side view of the necklace style embodiment of the portable plant container utilizing pods.

### DETAILED DESCRIPTION OF THE DRAWINGS

Referring to FIG. 1, a portable plant container apparatus 10 is shown which comprises a base portion 12, a cover portion 14, a root chamber 16 (also referred to as the culture medium container 16), and a means 18 for attaching the base portion 12 to a user, preferably at the wrist. A plant 20 is enclosed in the apparatus and comprises a root system 22 and an aerial portions 24. Although only one plant is shown, it is contemplated that multiple plants could be used with the present invention. The apparatus 10 is preferably made of a lightweight, material such as, but not limited to a polycarbonate material. This will minimize the weight of the container apparatus 10. The cover portion 14 and the culture medium container 16 are typically transparent such that the plant 20 can be viewed by the user while the plant 20 is growing. Cover 14 is preferably at least partially removable from base portion 12 such that access can be gained to the interior of container 10. The means 18 for attaching the base portion 12 to the user is shown as a wristband and buckle similar to that of a watch. Any known means to secure the apparatus 10 to the user is contemplated whether it be to the user's wrist, waist, pants, or other areas. Although shown as a wristband, the attachment means is also contemplated as a waist belt, necklace, pin, earring, or any other known jewelry attachment means. It is also contemplated that container 10 could be used attached to a pen, pocket watch, toys, or any other suitable application. Other types of bands or clips such as plastic, cloth, metallic, elastic, velcro, etc. could also be used and are contemplated herein.

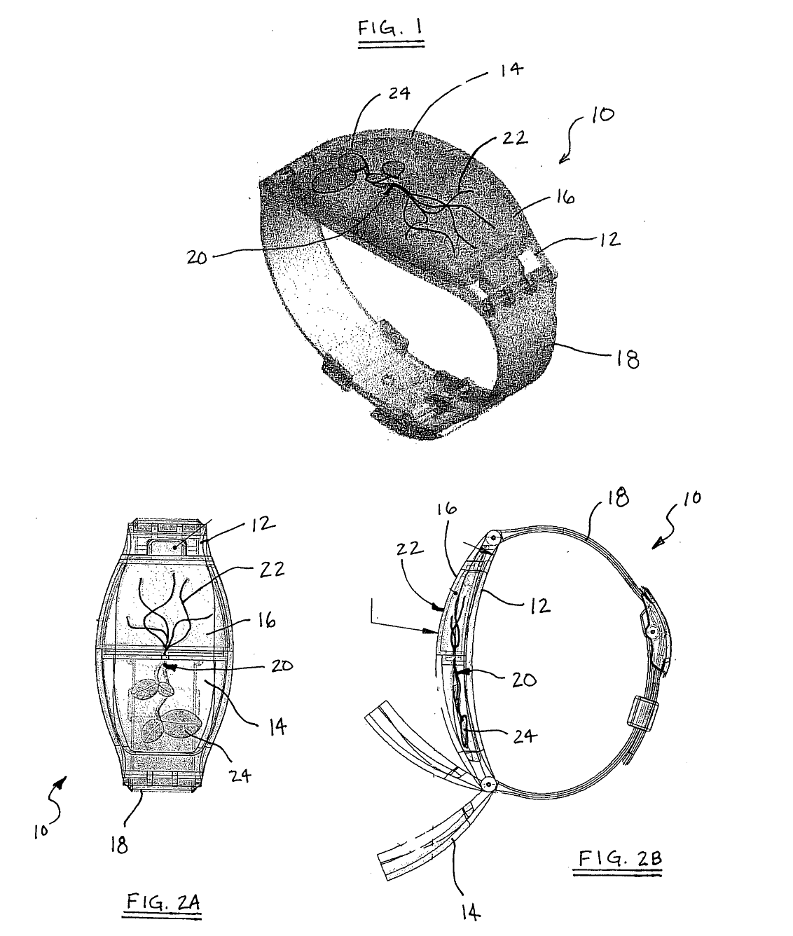

Referring now to FIGS. 2A-2B, the portable plant container apparatus 10 is shown in various views. FIG. 2A show a view the typical user would observe when looking down at the portable plant container apparatus 10. The user can see the entire plant 20 as the plant roots 22 are adjacent the leaves and stems 24, instead of having the leaves and stems 24 blocking the view of the roots 22. This allows viewing of the entire plant growth. FIG. 2B shows a side elevational view of the portable plant container apparatus 10. The cover portion 14 is shown in an open position, a closed position, and an intermediate position. The cover portion 14 is hingedly attached to the base portion 12 on one end. The cover portion 14 covers a growth chamber 30 which is the area provided by the portable plant container apparatus 10 for the growth of the leaves and stems 24. When the cover portion 14 is open, access is provided to the leaves and stems 24. This allows the user to remove any dead portions or trim the plant 20 as needed.

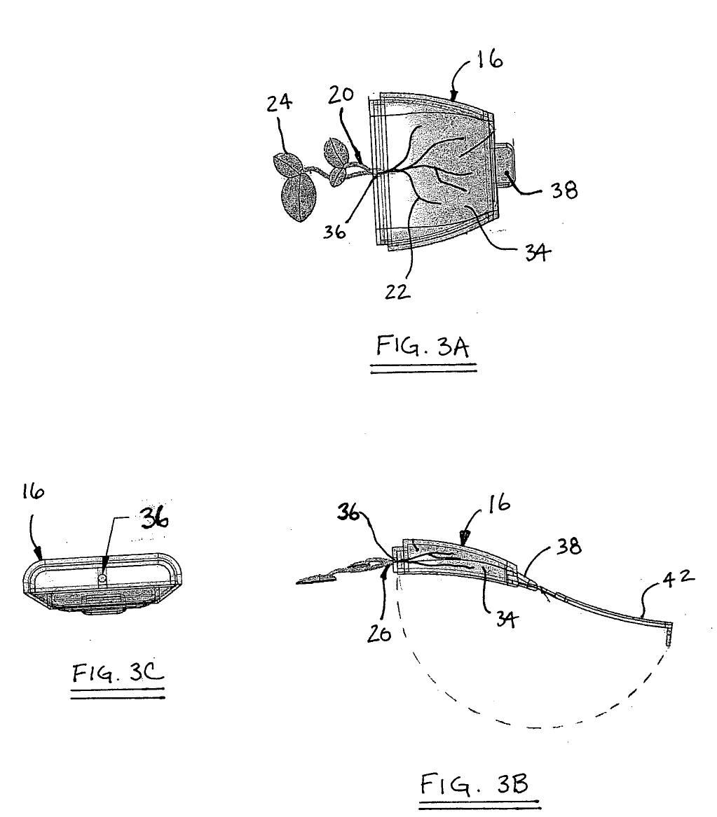

The culture medium container 16 is best shown in FIGS. 3A-3C. The culture medium container 16 can be made of a transparent plastic material, but is not intended to be limited as such. The culture medium container 16 forms a root chamber which is filled with a transparent culture material 34. Culture materials 34 or gelling agents are typically colorless. It is contemplated that different dyes can be used with culture material 34 and, therefore, be more attractive to children. The different colors may also provide an ability to color-code plant cultures for particular plants. The color tint will add to the aesthetic appearance of container 10 while at the same time, allowing higher visibility to roots 22 within transparent culture material 36. An aperture 36 is formed in a wall of the culture medium container 16 and allows the plant to grow from the root chamber 16 to the growth chamber 30. The culture medium container 16 comprises a container cover 42 which allows access to the interior of the culture medium container 16. This makes it easy to remove the culture material 34 and the grown plant 20 which is ready to be transplanted to a stationary location. The culture medium container 16 also has a tab 38 formed thereon which allows the culture medium container 16 to be removably attached to the base 12. Although shown as a separate container, culture medium container 16 could be as simple as a recess in the base, especially when the culture material in not in liquid form.

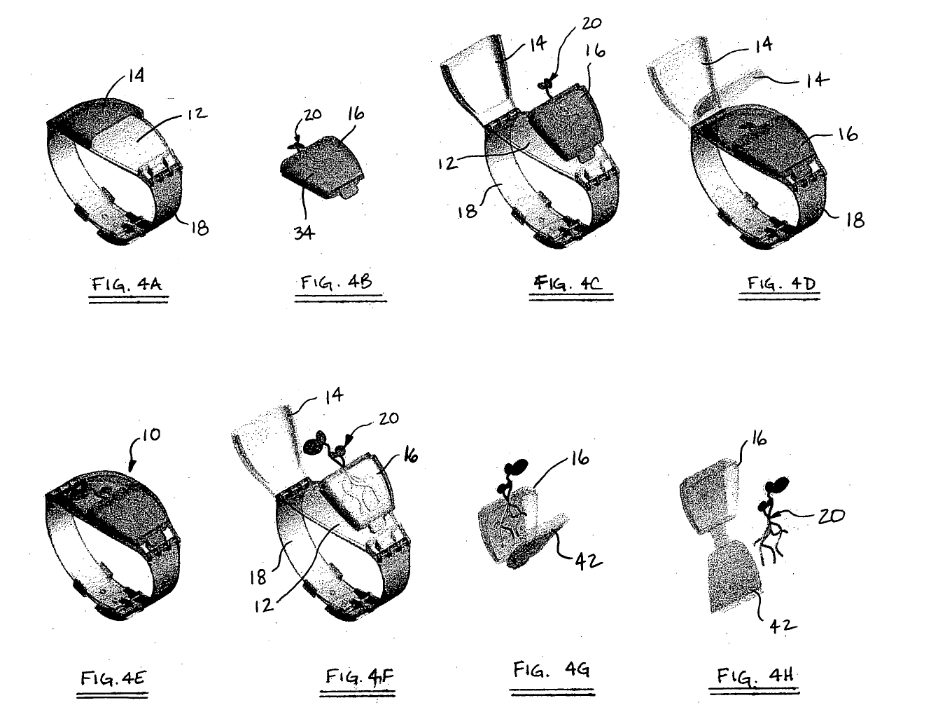

The method 40 of using apparatus 10 is shown in FIGS. 4A-4H. The user purchases the apparatus 10 which typically comes with the culture material container 16 provided separately. The culture material container 16 is filled with tissue culture 34 forming a root chamber for an included plant 20. The plant 20 may be in the form of a seed embedded in the tissue culture near aperture 36, or of a seedling having sprouts 20 protruding through aperture 36. The culture material container 16 is then attached to the base 12 by snapping the tab 38 into a receiver portion in base 12. The cover 14 is then moved downward and snaps into position over at least an end of the culture material container 16. The apparatus 10 is then worn by the user until the plant 20 is grown and ready to be transplanted. To remove the plant 20, the cover 14 is lifted and the culture material container 16 is removed from base 12. The culture material container door 42 is then opened to access the plant 20 and the plant 20 is then removed from the culture material container 16. The plant 20 is then ready to be planted in the soil. The apparatus 10 is reusable and a new seed or seedling 20 can be grown in the device 10.

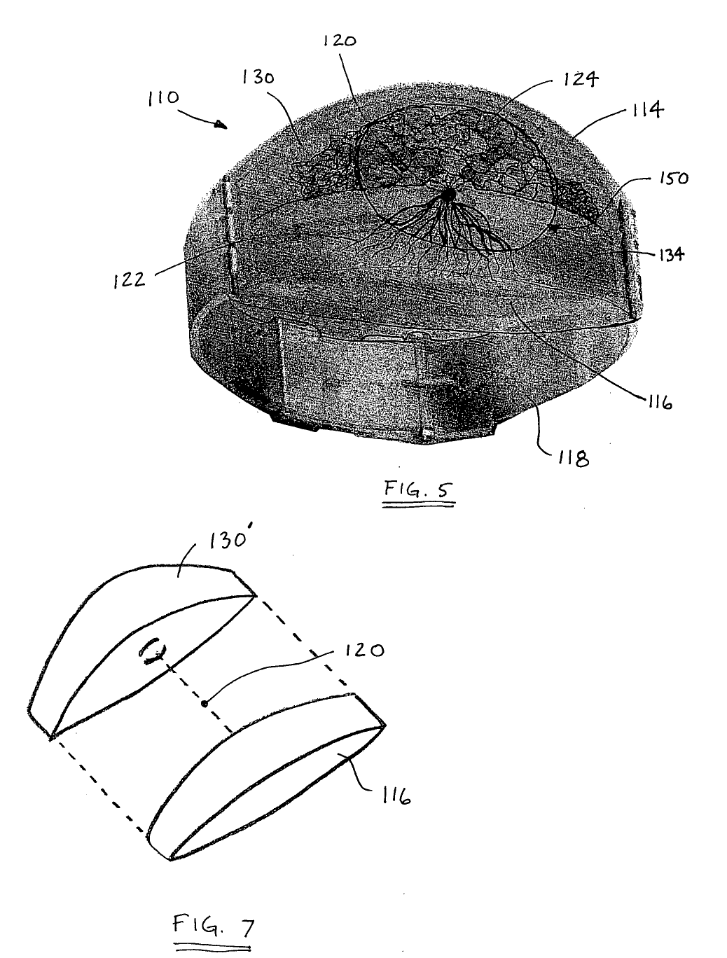

Another embodiment is shown in FIG. 5 showing a portable plant container 110 which comprises a cover portion 114 and optionally a base portion 112. A culture material 134, is provided in a plastic root chamber 116, is positioned within and secured to cover portion 114, or optionally secured to base portion 112. Culture material 134 is surrounded by a thin transparent plastic material forming root chamber 116. A plant 120 is shown within container 110 having roots 122 networked within culture material 134 in the root chamber 116 and shoots 124 extending into an open volume 130, or growth chamber, contained by cover portion 114. Container 110, or at least cover portion 114, is preferably made of a lightweight, transparent material such as, but not limited to a polycarbonate material. This will minimize the weight of the container and allow the contents to be viewed. Cover 114 is preferably removable from base portion 112 such that access can be gained to the interior of container 110. Cover 114 can also be configured with an integral magnifying lens 150 to enable the user to better view the plant 120. Container 10 comprises an attachment means 118 for attaching container 110 to a user as shown in the previous embodiment. Base portion 112 or cover portion 114 is contemplated to be either integral to attachment means 118 or separate from and detachably attachable to attachment means 118 by the use of hinge pins, clips, hooks, screws, Velcro or any other suitable attachment. This will allow the user to switch containers 110 on a specific attachment means 118, if desired.

Referring to FIG. 6A-6G, the method of using the apparatus 110 comprises the steps of providing a plant tissue medium container 110. At least one pre-germinated seed 120 is selected for use in container 10. Cover 112 of container 110 is removed or positioned to allow insertion of root chamber 116 containing culture material 136. The pre-germinated seed 120 is placed within culture material 136 through a hole cut in the thin transparent plastic material of the root chamber 116 covering culture material 136. The seed 120 is allowed to grow within container 110. Once plant 120 fills growing space 130, plant 120 and root chamber 116 are removed from container 110 and transplanted to soil. Once transplanted, root chamber 116 will biodegrade allowing roots to take hold in the soil as shown. If the root chamber 116 is not made of a biodegradable substance, the root chamber 116 is cut-away from the plant 120 prior to planting the plant 120 in soil. Container 110 is reusable by simply inserting another root chamber 116 enclosing culture material 136 and a seed 120.

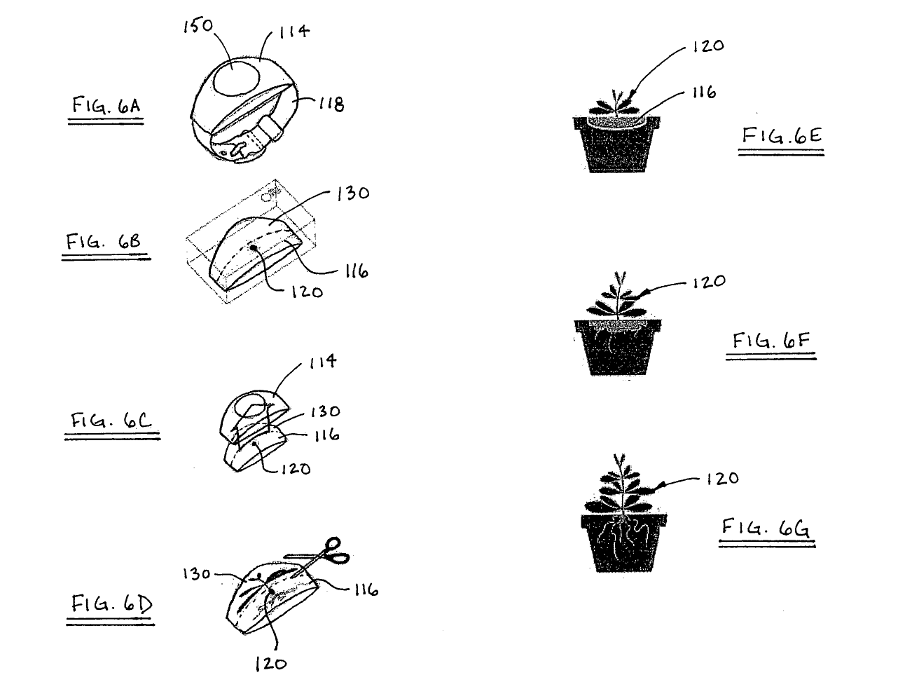

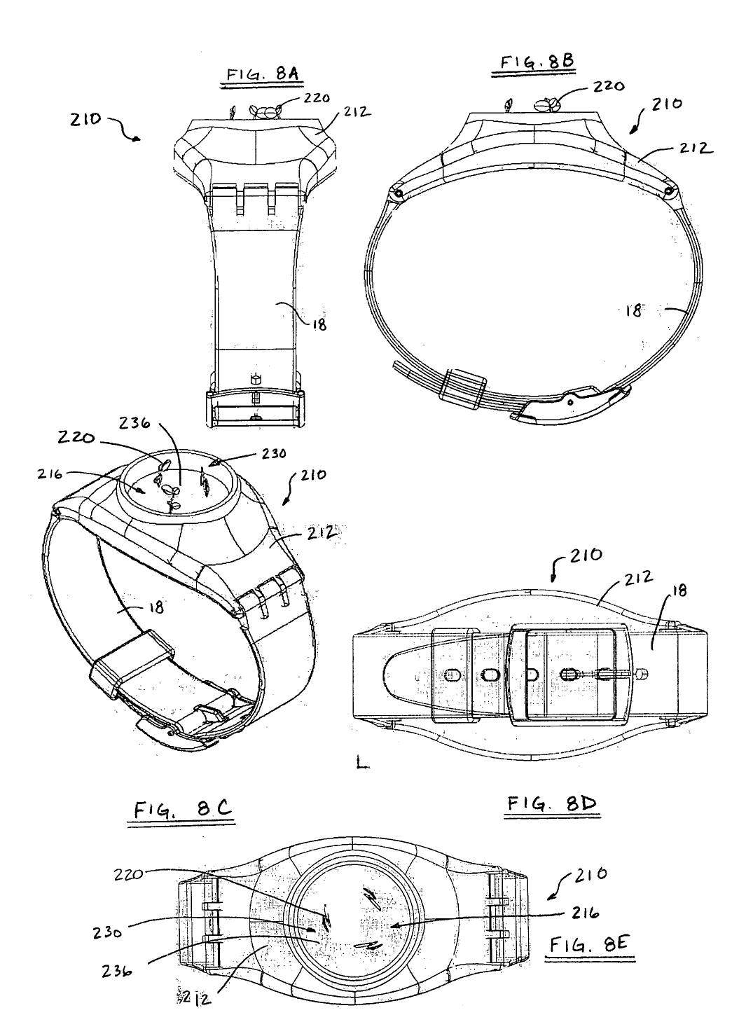

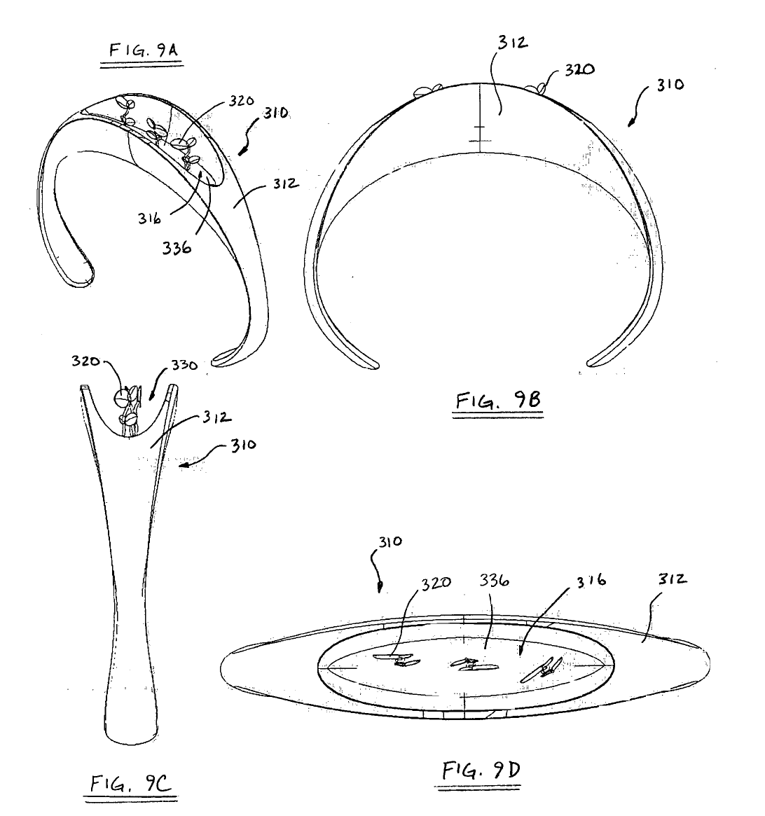

In an alternate embodiment, as shown in FIG. 7, culture material 136 is provided from the factory sealed in a root chamber 116 of plastic material and bonded to growth chamber 130′ also sealed in a plastic material. A germinated seed 120, or a pre-germinated seed which is subsequently germinated, is sealed between root chamber 116 and growth chamber 130′. The assembled components are then shipped to a user. The plant 120 grows from pre-germinated seed 120 into sealed root chamber 116 and growth chamber 130′. When ready for transplanting, growth chamber 130′ is cutaway. Sealed root chamber 116 is preferably biodegradable and can simply be placed into the soil.

Another embodiment of the present invention is shown in FIGS. 8A-8E. The portable plant container 210 is shown with a generally circular and centrally positioned root chamber 216 formed in base 212. The root chamber 212 contains a growth material 236 which may be a culture sponge, soil, or any other suitable growth material. A plurality of plants 220 are shown growing up from the base 212. The growth chamber 230 above the root chamber 216 may be covered by a transparent cover (not shown) which may be further enhanced by having at least a portion of the cover being a magnifying lens. The container 210 is secured to a user with band 18.

Another embodiment is shown in FIGS. 9A-9D. The portable plant container 310 is shown in the form of a cuff bangle. The cuff bangle body 312 comprises an ovular and centrally positioned root chamber 316 formed in base 312. The root chamber 312 contains a growth material 336 which may be a culture sponge, soil, or any other suitable growth material. A plurality of plants 320 are shown growing up from the base 312. The growth chamber 330 above the root chamber 316 may be covered by a transparent cover (not shown) which may be further enhanced by having at least a portion of the cover being a magnifying lens. The container 310 may be made of a fashionable material and colors to enhance the aesthetic appearance of cuff bangle 310. The container 710 is secured to a user with cuff bangle band 118.

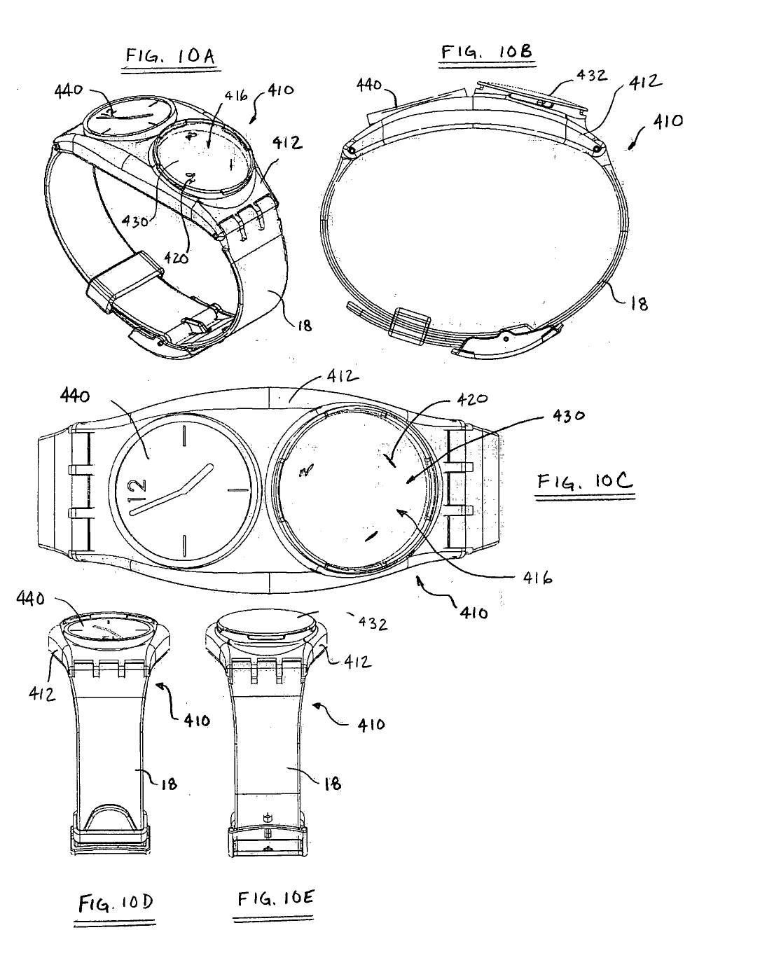

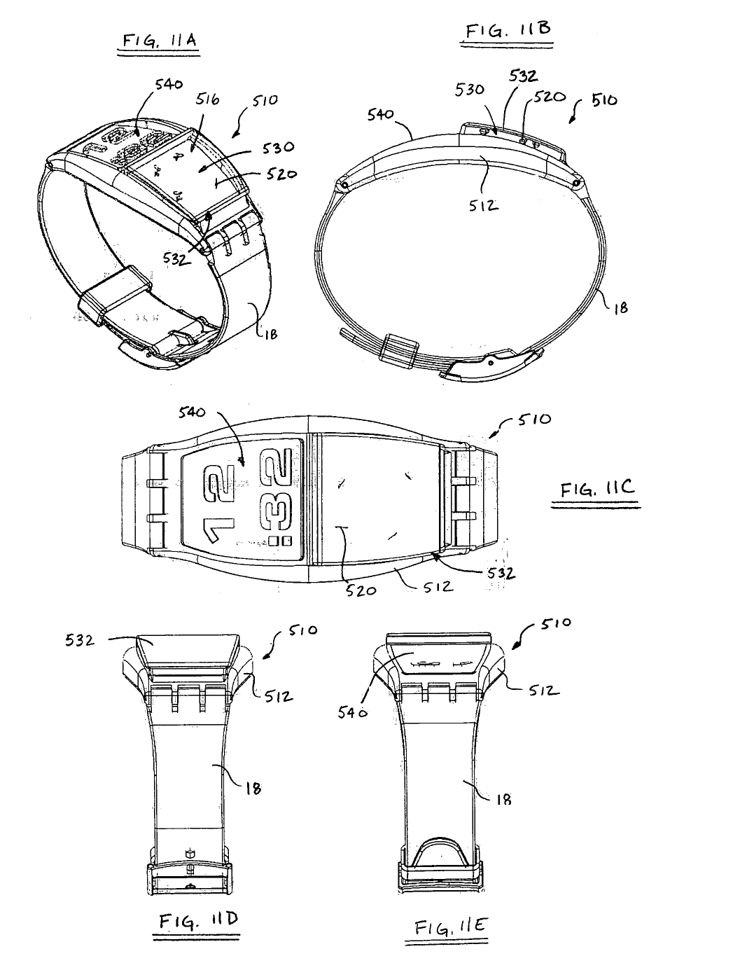

Referring now to FIGS. 10A-10E, an embodiment of the present invention includes a time feature. Portable plant container 410 is similar to the embodiment shown in FIGS. 8A-8D, however the plant root chamber 416/growth chamber 430 containing plants 420 has been moved off center of base 412 and is adjacent to a clock 440. The clock 440 may be of the face and hands type shown or an LED display or the like. The clock 440 allows the container 410 to be used as a watch as well as a personal plant growth device. The growth chamber 430 is protected by a detachable cover 432. The container 410 is secured to a user with band 18.

Referring now to FIGS. 11A-11E, another embodiment of the present invention includes an LED time feature. Portable plant container 510 is similar to the embodiment shown in FIGS. 10A-10D, however the plant root chamber 516/growth chamber 530 containing plants 520 and the clock portion 540 generally conform to the shape of base 512. As with the previous embodiment, the clock 540 allows the container 510 to be used as a watch as well as a personal plant growth device. The growth chamber 530 is protected by an access cover 532 which is shown elevated above the surface of the clock 540 to allow additional space for the growth chamber 530. The container 510 is secured to a user with band 18.

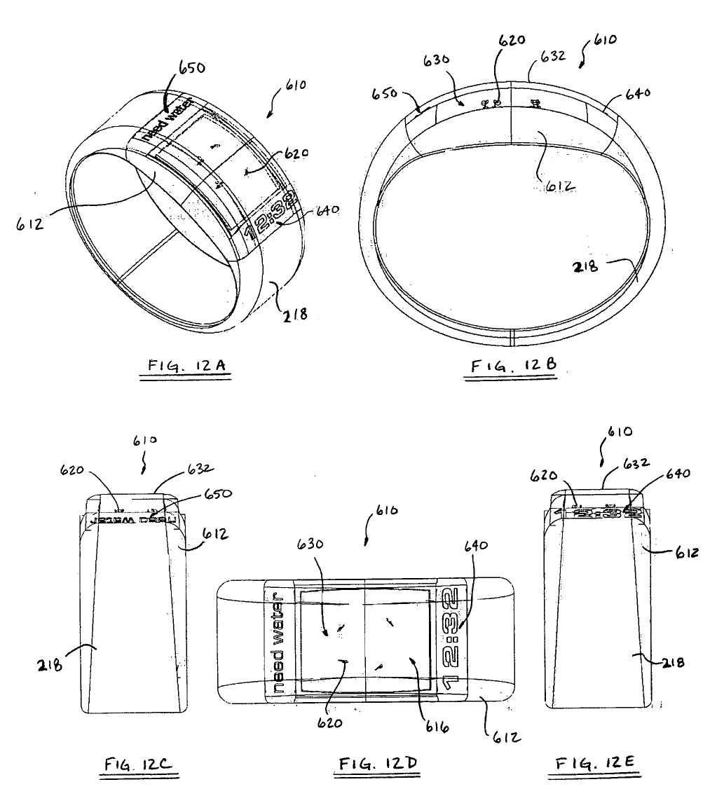

Another LED version of the watch feature is shown on an embodiment of the portable plant container 610 in FIGS. 12A-12E. The LED clock display 640 is shown adjacent an offset growth chamber 630. The portable plant container 610 further comprises a means 650 for notifying the user that the plants 620 are in need of some type of attention. The means 650 may be in the form of a specialized audible alarm and/or a visual display in picture and/or text form. While generally plants 620 grown in a hydroponic growth medium 616 will not need anything such as sunlight or water, the messages could be messages such as “read to me”, “sing to me”, or “talk to me”, etc. If the growth medium 616 is soil, the plant will require water and the message may be “need water” or “need sun”. The activation of the notification system may utilize sensors (not shown) or may use timed intervals from the last watering. Another feature of the container 610 is solar panels 660 positioned on the sides of the container base 612. The solar panels 660 may be used to power the clock 640 as well as the means 650 for notifying the user that the plants 620 are in need of some type of attention. The growth chamber 630 is protected by a cover 632. The container 610 is secured to a user with band 218.

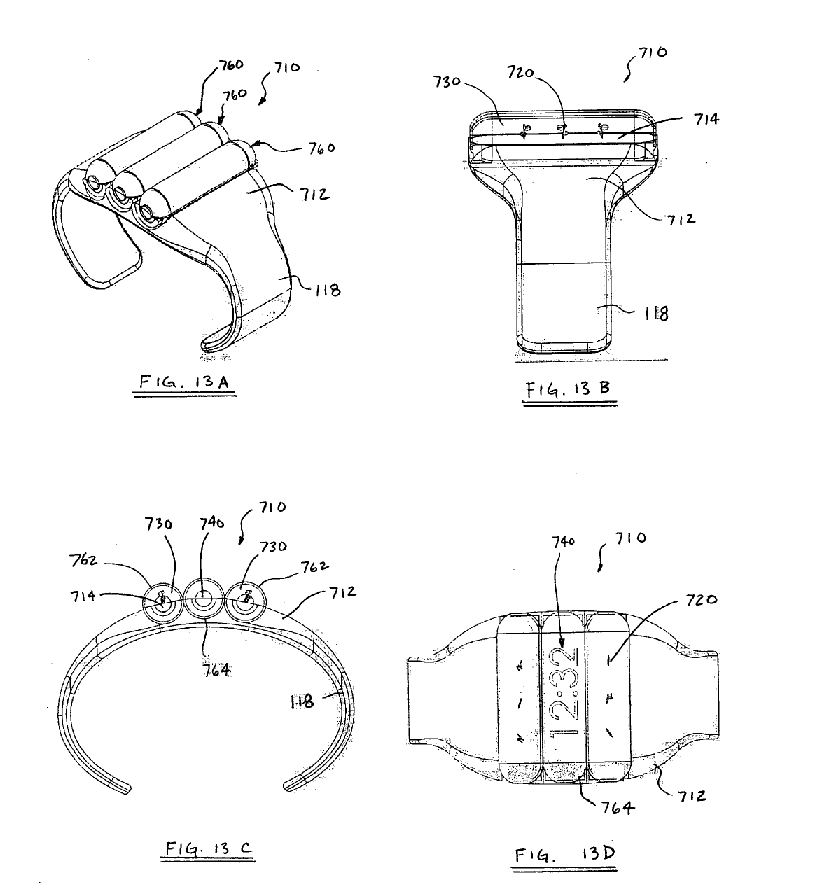

Still another embodiment is of the portable plant container 710 is shown in FIGS. 13A-13D. This portable plant container 710 is shown as a cuff bangle and utilizes a plurality of removable pods 760 attached to the bangle base 712. One pod 762 contains a growth material 714 and a plurality of plants 720 protruding from the growth material 714 into a growth space 730. The pods 760 are generally transparent so that the plants 720 may be viewed. The pods 760 may be tinted a particular color to accessorize with the users clothes and/or jewelry. Different pods can be substituted into the container 710 as desired by the user. Another pod 764 contains a clock 740 shown in the form of an LED display. The pods 760 may also include lighting (not shown) for the clock and/or plants 720 such that the pods 760 may be seen in the dark. An LED message pod (not shown) and/or audio alarm associated with the message pod or the clock pod is also contemplated. The container 710 is secured to a user with cuff bangle band 118.

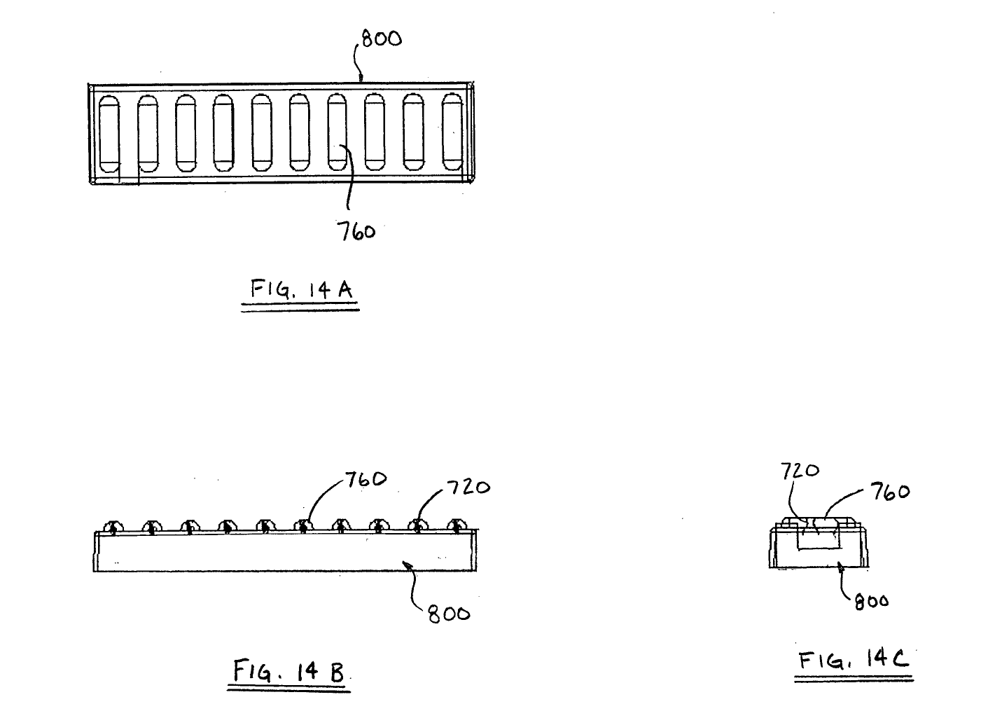

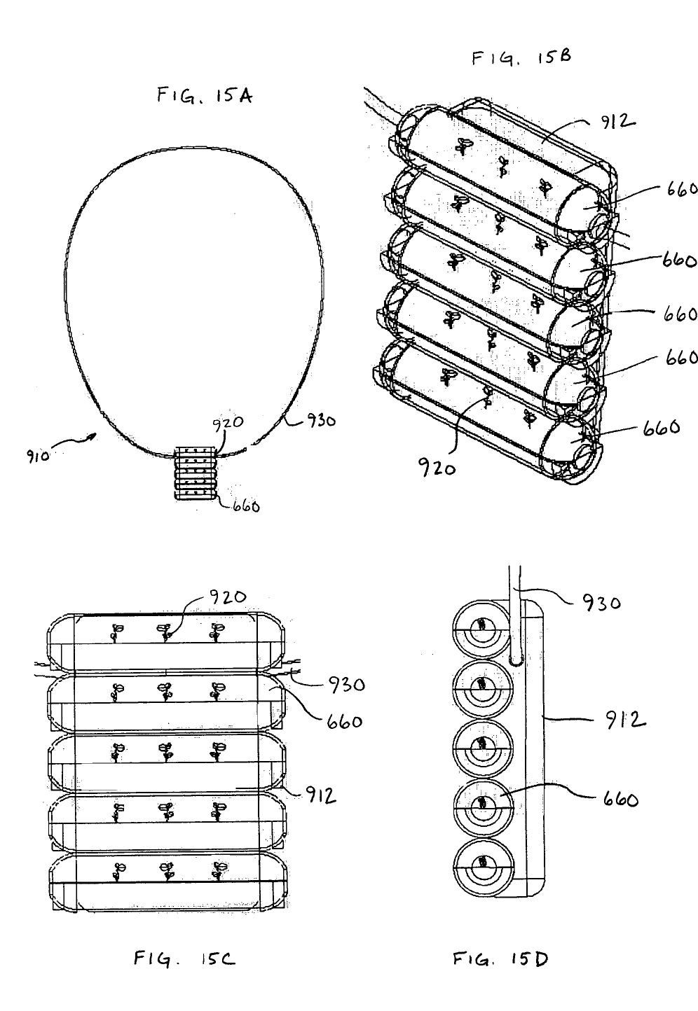

The plurality of pods 760 may be stored in a pod box 800 as shown in FIGS. 14A-14C and substituted into the container 710 as needed by the user. In addition to the different color shades of the pods 760, the pods 764 may have different color plants such as flowering plants or the like. Different color light pods 760 are also contemplated. The pod box 800 is used to display and store the pods in a manner that the user can easily see the different color, plant, light, message, and/or clock pods 760 and select the pods 760 that the user would like to wear on that particular occasion.

Referring now to FIG. 15A-D, a portable plant container 910 is shown in the form of a necklace. The necklace 910 utilizes a plurality of pods 660 having a plurality of plants 920 attached to a pod base 920. The necklace 910 includes a chain 930 for attaching the necklace 910 to the user.

As stated, a variety of materials, configurations, and applications can be employed in the practice of this invention. It is to be understood that such variations are intended to fall within the scope of the claimed invention and that the subject invention is not to be limited by the specific apparatus or method of operation described and/or depicted by the drawings nor is the invention to be limited by the specific materials and mechanical components identified and described herein. These have been designated merely to provide a demonstration of operability and the selection of mechanically equivalent arrangements is not deemed a departure from the spirit of the invention being limited solely by the scope of the attached claims.

1. A portable plant container comprising:
a base portion;
a cover portion attached to the base portion and at least partially removable from the base portion;
a root chamber formed in the base portion;
a growth material positioned in the root chamber;
a plant inserted at least partially in the growth material;
a growth chamber formed between the root chamber and the cover portion;
a clock attached to the base portion and positioned adjacent the cover; and
means for attaching the base portion to a user.

2. The portable plant container of claim 1 further comprising a means for periodically notifying the user to attend to the plant's needs.

3. The portable plant container of claim 2 further comprising a solar power means for providing electricity to the clock or the means for periodically notifying the user to attend to the plant's needs.

4. The portable plant container of claim 2, wherein the means for periodically notifying the user to attend to the plant's needs comprises an audible alarm.

5. The portable plant container of claim 2, wherein the means for periodically notifying the user to attend to the plant's needs comprises a visual message.

6. The portable plant container of claim 1, wherein the cover portion is made of a transparent material.

7. The portable plant container of claim 2, wherein the cover comprises an integral magnifying lens.

8. The portable plant container of claim 1, wherein the means for attaching the base portion to a user comprises at least one band to attach the base portion to the user.

9. The portable plant container of claim 1, wherein the cover is selectively positionable to an opened position providing access to at least the growth chamber of the container.

10. The portable plant container of claim 1, wherein the culture material comprises a culture sponge.

11. A portable plant container comprising:
a base portion;
a cover portion attached to the base portion and at least partially removable from the base portion;
a root chamber formed in the base portion;
a growth material positioned in the root chamber;
a plant inserted at least partially in the growth material;
a growth chamber formed between the root chamber and the cover portion;
a means for periodically notifying the user to attend to the plant's needs; and
means for attaching the base portion to a user.

12. The portable plant container of claim 11 further comprising a solar power means for providing electricity to the clock or the means for periodically notifying the user to attend to the plant's needs.

13. The portable plant container of claim 12, wherein the means for periodically notifying the user to attend to the plant's needs comprises an audible alarm.

14. The portable plant container of claim 11 further comprising a clock attached to the base portion.

15. The portable plant container of claim 11, wherein the cover portion is made of a transparent material and comprises an integral magnifying lens.

16. A portable plant container comprising:
a base portion;
at least one strap attached to the base portion for securing the base to a wrist of a user;
a root chamber positioned in the base portion;
a growth material contained in the root chamber;
a plant inserted at least partially in the growth material;
a transparent cover portion attached to the base portion;
a growth chamber formed between the root chamber and the cover portion;
wherein the cover portion comprises a magnifying lens portion and is positionable over the growth chamber;
a clock attached to the base portion;
an audible alarm or visual message for periodically notifying the user to attend to the plant's needs;
a solar power means for providing electricity to the clock or the audible alarm or visual message for periodically notifying the user to attend to the plant's needs.

17. The portable plant container of claim 16, wherein the growth material is soil.

18. The portable plant container of claim 16, wherein the growth material is a hydroponic culture material.
